(19) United States
(12) Patent Application Publication
(10) Pub. No.: US 2022/0112000 A1
(43) Pub. Date: Apr. 14, 2022

(54) SEMI-RIGID CARTON POUCH PACKAGE

(71) Applicant: SFC GLOBAL SUPPLY CHAIN, INC., Marshall, MN (US)

(72) Inventors: Mark MIKOL, Eden Pairie, MN (US); Bonita M. Hinze, Prior Lake, MN (US); Mark A. Manzi, Mason, OH (US)

(21) Appl. No.: 17/501,849

(22) Filed: Oct. 14, 2021

Related U.S. Application Data
(60) Provisional application No. 63/091,514, filed on Oct. 14, 2020.

(51) Int. Cl. B65D 30/20; B65D 33/00; B65B 41/12; B65D 75/00; B65B 9/13; B65B 61/06; B65D 75/42

(52) U.S. Cl. CPC B65D 31/10; B65D 33/001; B65B 41/12; B65D 75/42; B65B 9/13; B65B 61/06; B65D 75/008

(57) ABSTRACT

Paper-based packages and methods of making the same are disclosed. In one example, a semi-rigid package comprises: a base, a first side portion, and a second side portion. The base comprises two opposed major walls and two longitudinal side walls opposed to each other. The first side portion and a second side portion are integrally formed with the base. The two side portions are respectively connected to the base along the longitudinal direction, and each side portion comprises two opposed side panels, two tapered corner portions opposed to each other, and a closure in a transverse direction. Each side panel is connected to the adjacent major wall along a transverse line, and the two opposed side panels are jointed to form the closure. At least one of the side portions may be substantially compacted and form a substantially flat transverse side wall.

### CROSS REFERENCE TO RELATED APPLICATION

This application claims benefit of U.S. Application Ser. No. 63/091,514, filed Oct. 14, 2020, the disclosure of which is incorporated herein in its entirety.

### FIELD OF THE INVENTION

The present disclosure relates generally to packaging for consumer products, to inline carton forming methods and apparatus for forming, filling, and sealing such packaging, and to the finished packaged product.

### BACKGROUND

Single-use packaging, including pouches, bags, and cartons, are widely used to contain and protect various consumer good products, but the sustainability, recyclability, and carbon footprint of single-use packaging materials is a growing concern. For example, thin recyclable films, such as those commonly used in shrink wrap pouches or plastic grocery bags can clog commercial recycling equipment and in practice these packaging streams are rarely recycled. As another example, recyclable paperboard cartons require the use of thicker, semi-rigid paperboard in order to tolerate high speed carton forming operations. And although this paperboard material is 100% recyclable, the use of thicker materials increases the carbon footprint of the package. Therefore, it would be desirable to provide a reduced carbon footprint package made with thinner recyclable paperboard or cardstock that can tolerate high speed carton forming and to provide a method and process capable of forming the thinner material into a package at high speed.

### SUMMARY

A package or container for protecting, transporting, and storing a consumer goods product and a process and method for making the package at commercial production speeds is disclosed. The package can provide adequate protection to the product contained inside with a reduced carbon footprint. In general, the package is made from paper-based materials formed on roll-fed form, fill, seal (hereinafter FFS) packaging equipment or manufacturing line.

In one aspect, the present disclosure provides a package. The package may be in a form of a carton pouch or the like. In one example, a package comprises a housing, and the housing comprises: a base comprising two opposed major walls, and two longitudinal side walls opposed to each other; a first side portion and a second side portion integrally formed with the base, wherein the two side portions are respectively connected to the base, wherein each side portion comprises two opposed side panels, two opposed corner portions, and a transverse closure, wherein each side panel is connected to the adjacent major wall along a transverse line, wherein the two opposed side panels of each side portion are jointed and sealed by an interlocking mechanism to form the transverse closure, and wherein the corner portions are tapered. In preferred embodiments, the housing is made from a paper blank. The paper blank may comprise a plurality of preparations including but not limited to cut-outs, perforations, scores, folding lines, printing or graphic element, interlocking mechanisms such as pre-applied bonding or sealing material, heat or pressure sensitive adhesive, and combinations thereof. The plurality of preparations may provide means or guidance to fold and configure the paper blank as well as to form, shape, and seal the package.

The housing is semi-rigid and provides three-dimensional structural stability on shelf In some embodiments, the housing can be self-standing on a horizontal surface that is against either one of the major walls or one of the longitudinal side walls. The self-standing housing can withstand a weight or a force in the X, Y, and Z directions, remain stable on the horizontal surface, and remain substantially unchanged in shape or configuration absent content therein or regardless of the type of content therein. In some embodiments, the semi-rigid housing encloses a content therein and does not conform to the content in shape.

The housing may have various configurations. In some embodiments, at least one of the side portions has a substantially compacted configuration. In some embodiments, at least one compacted side portion comprises a transverse side wall that is formed by folding and compressing the side panels of at least one compacted side portion inwardly along the longitudinal axis. In some embodiments, the transverse side wall of at least one compacted side portion may be substantially flat and generally perpendicular to the two major walls.

The transverse closures may have various configurations. In some embodiments, the transverse closure may generally protrude from the corresponding transverse side wall. In some embodiments, the transverse closure is positioned flat to conform to the transverse side wall. In some embodiments, the flat transverse closure may be fixed by a tape or bonding material.

In some embodiments, both the first and second side portions are substantially compacted and each of the compacted side portions has a transverse side wall that is substantially flat and generally perpendicular relative to the two major walls. In some embodiments, both transverse closures respectively protrude from the corresponding transverse side wall. In some embodiments, both transverse closures are respectively positioned flat to conform to the corresponding transverse side walls.

In some embodiments, the housing of the package further comprises at least one fin seal or lap seal on at least one of the major walls along the longitudinal direction. In some embodiments, the housing further comprises a printing or graphic element disposed on at least a portion of an exterior surface of the housing. In some embodiments, the housing further comprises a coating disposed on an interior surface or an exterior surface thereof. The coating may be at least one of: a water-resistant coating, an oil-resistant coating, a barrier coating, etc.

In some embodiments, the interlocking mechanism comprises a sealable layer, a tape, a bonding material, an adhesive, or combination thereof. The interlocking mechanism may comprise a material or coating that is heat sensitive, pressure sensitive, or ultrasound sensitive. In some embodiments, the interlocking mechanism may be provided from an external source and applied to the housing during an in-line packaging process. In some embodiments, the interlocking mechanism comprises a continuous pattern or an intermittent pattern, or both. In some embodiments, the interlocking mechanism is disposed on an edge portion of one or both of the side panel(s). In some embodiments, the interlocking mechanism is initiated by heat, pressure, or ultrasonic vibration.

In a preferred embodiment, the package is formed from a paper roll comprising a continuous web having a plurality of blanks, wherein every two adjacent blanks of the plurality of blanks are at least partially connected along an edge of each of the two adjacent blanks. In some embodiments, the paper roll comprises a paper-based material having a thickness from about 0.5 points to about 24 points.

In some embodiments, the package further comprises an item disposed and enclosed in the housing. The item may be a food product or a non-food product. In some embodiments, the food product enclosed in the housing is a solid food or a frozen food. In some embodiments, the item takes up about at least 10%, or at least about 20%, or at least about 30%, or at least about 40%, or at least about 50%, or at least about 60%, or at least about 70%, or at least about 80%, or at least about 90%, or at least about 99% of an interior space of the housing, based on the total volume of the interior space.

In another aspect, the present disclosure provides a multi-unit package. The multi-unit package generally comprises a plurality of the packages described herein. In one example, every two adjacent packages of the multi-unit package are connected via a connection between a transverse closure of one package to a transverse closure of the other package. The multi-unit package is made from a paper roll comprising a continuous web having a plurality of connected blanks described herein.

In some embodiments, each connection between every two adjacent packages of the multi-unit package is elongated along the longitudinal direction to allow the packages to be rotatable about the connection and repositionable relative to the adjacent package. In some embodiments, the multi-unit package has a stacked configuration, wherein the packages are stacked over each other wherein the elongated connections are folded without breaking. In some embodiments, the multi-unit package further comprises an adhesive between every two adjacent packages to maintain the stacked configuration. In some embodiments, the multi-unit package further comprises a band or wrapper that fixes the stacked packages.

In yet another aspect, the present disclosure provides a method for making a package described herein. In one example, a method comprising: feeding a paper roll stock comprising a continuous web having a plurality of connected blanks; partially forming each of the plurality of blanks to generate a package, wherein the package is partially closed and comprises at least one opening; filling each partially-closed package with an item through at least one opening; forming each filled package to generate a housing that encloses the item; and closing the housing to form a packaged product.

In some embodiments, the method is executed on a horizontal form-fill-seal (FFS) line. In some embodiments, the method is executed on a vertical form-fill-seal (FFS) line.

In some embodiments, the method comprises continuously forming a plurality of packaged products from a web of a paper-based roll stock without breaking the web, wherein the web contains plurality of connected paper blanks, and wherein each blank is formed into one packaged product.

In some embodiments, wherein every two adjacent packaged products are connected via a connection between a transverse closure of one packaged product and a transverse closure of another packaged product. The method may further comprise cutting off the individual packaged products from the roll stock by breaking the connection.

In some embodiments, the method further comprises converting or transforming the individual packaged product to form at least one transverse side wall that is substantially flat. In some embodiments, the method further comprises positioning transverse closures or end seals that protrude from the transverse side walls to conform to the transverse side wall and securing the closure, or closures, flat.

In some embodiments, the method further comprises cutting off a multi-unit package from the roll stock, wherein the multi-unit package has a plurality of connected packaged products. In some embodiments, the method further comprises stacking the connected packages over each other along a height thereof without breaking the connections. In some embodiments, the method further comprises fixing the configuration of the stacked multi-unit package.

### BRIEF DESCRIPTION OF THE DRAWING AND FIGURES

FIG. 1 illustrates a perspective view of one example carton pouch 10 according to the present disclosure.

FIG. 2A illustrates a front perspective view of one example of carton pouch 100.

FIG. 2B illustrates a side perspective view of the carton pouch 100.

FIG. 2C illustrates a bottom view of the carton pouch 100.

FIG. 2D illustrates a top view of one unfolded blank 100′ of the carton pouch 100.

FIG. 2E illustrates a perspective view of a partially folded carton blank 100.

FIG. 2F illustrates a perspective view of one example corner portion 120 of the carton pouch 100.

FIG. 2G illustrates a perspective view of one example paper roll 180 and an unwound portion thereof, where the paper roll 180 comprises a plurality of connected blanks 100′.

FIG. 2H illustrates a top view of one example of a multi-unit package 195 comprising a plurality of connected carton pouches 100.

FIG. 2I illustrates a side view of the multi-unit package 195 according to FIG. 2H.

FIG. 3A illustrates a front perspective view of one example of carton pouch 200.

FIG. 3B illustrates a top perspective view of the carton pouch 200.

FIG. 3C illustrates a side view of a configuration of the side portion 102 of the carton pouch 100.

FIG. 3D illustrates a side view of a configuration of the side portion 202 (or 203) formed from transforming the configuration of FIG. 3C.

FIG. 3E illustrates a side view of another configuration of the side portion 202 (or 203) formed from transforming the configuration of FIG. 3D.

FIG. 3F illustrates a perspective view of a corner portion 250 of the carton pouch 200.

FIG. 3G illustrates a side view of a multi-unit package 295 comprising a plurality of connected carton pouches 200.

FIG. 4A illustrates a front perspective view of one example of carton pouch 300.

FIG. 4B illustrates a top perspective view of the carton pouch 300.

FIG. 4C illustrates a top view of an unfolded carton blank 300′ corresponding to the carton pouch 300.

FIG. 4D illustrates a perspective view of one configuration of the corner portion 320 according to FIG. 4A.

FIG. 4E illustrates a perspective view of another configuration of the corner portion 320.

FIG. 4F illustrates a side view of one configuration of the side portion 302.

FIG. 4G illustrates a perspective view of another configuration of the side portion 302 of FIG. 4F.

FIG. 4H illustrates a top view of a continuous web 381 comprising a plurality of connected blanks 300′.

FIG. 4I illustrates a multi-unit package 395 comprising a plurality of connected carton pouches 300.

FIG. 4J illustrates a side view of the connection 382 between two adjacent carton pouch 300.

FIG. 4K illustrates a side view of one configuration of the multi-unit package 395.

FIG. 4L illustrates a side view of a stacked configuration of the multi-unit package 395.

FIG. 4M illustrates a perspective view of another example of the carton pouch 300.

FIG. 4N illustrates a side view of carton pouch 300 of FIG. 4M.

FIG. 5 illustrates a block diagram of one example of horizontal FFS process to make the present carton pouch or packaged product.

FIG. 6 illustrates a block diagram of one example of vertical FFS process to make the present carton pouch or packaged product.

FIG. 7A illustrates a block diagram of one example method of making the present carton pouch or packaged product.

FIG. 7B illustrates a block diagram of one example operation 712 according to FIG. 7A.

FIG. 7C illustrates a block diagram of another example operation 712 according to FIG. 7A.

### DETAILED DESCRIPTION

The present disclosure provides an innovative approach for providing a more sustainable package alternative to conventional cartons and flexible pouches. The carton pouch is a novel package made from a continuous roll of paper-based material with the surprising stiffness and durability of a carton allowing for thinner material to be used versus standard cartons. In addition, the carton pouch package can be designed to be self-standing without appearing saggy or droopy and without distortion, unlike most polymer-based, or fossil fuel based, flexible pouches.

Exemplary packages that protect the product and the process and method for forming the package are depicted in the figures. Configurations, materials utilized, etc., are described below. The dimensions are merely exemplary and may be modified accordingly as required or desired for a particular application. Other embodiments, configurations, dimensions, etc., are also contemplated.

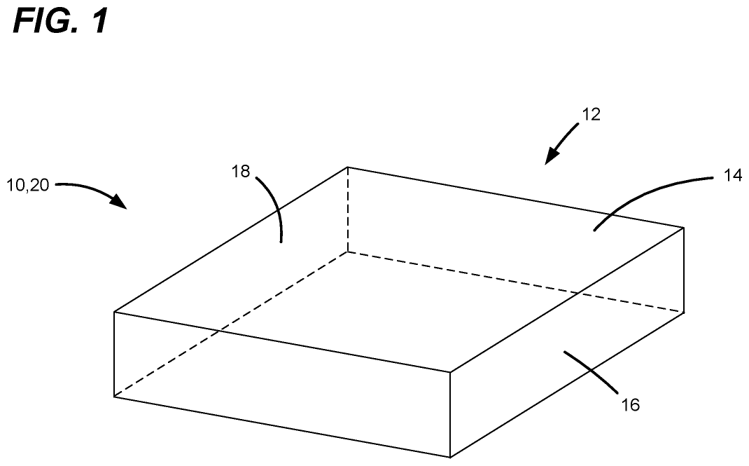

FIG. 1 is a schematic illustration of one general example of the carton pouch according to the present disclosure. In the illustrated example, the carton pouch 10 includes a housing 12 that encloses an interior space 14. The housing 12 has an exterior surface 16 and an interior surface 18. The interior space 14 is configured to contain and protect an item (not shown) placed therein. In some embodiments, the present disclosure relates to a packaged product 20 that includes both the carton pouch 10 and the item placed therein.

The carton pouch 10 is useful for packaging various types of the item. In some embodiments, the item is a food product. The food product may be a frozen food, such as pizza, egg rolls, enrobed dough foods, pies and snack foods, refrigerated foods and shelf stable foods. The carton pouch 10 may contain a single food product or multiple food products.

Additional non-limiting examples of the frozen food product include frozen meals, noodles, pot stickers, stir-fry, pizza, pies, ice cream products, desserts, burritos, vegetables, fruit, frozen meats, meatballs, potato products, egg rolls, dumplings, frozen dinners, breakfast foods, or others. The food product may be a non-frozen food product, shelf-stable food product, snack product, or baking product, such as dried fruit, nuts, cereal, granola, chips, cookies, spices, candy, croutons, crackers, mints, gum, soup mix, dehydrated foods, drink mixes, drink additives, flour, sugar, cornstarch, chocolate chips, or others. The food product may be large, small, solid, frozen, unfrozen, pourable, block, particulate, granulate, flowable, pelletized, granulated, powder, or in another form.

In some embodiments, the food product is a solid or semi-solid at the temperature the product is stored at. Exemplary stored temperatures may be room temperature, may be 72° F., may be 100° F., may be refrigerated temperatures (32° F. to 45° F., or 35° F. to 40° F.), or may be frozen temperatures (−10° F. to 32° F. or −5° F. to 10° F.). A flowable solid could include products such as a frozen juice concentrate, frozen soup mix, or sauce where the liquid in the food product has been sufficiently sequestered away from the carton pouch by virtue of being stored at a temperature below its freezing point, because of the nature of the food product keeping the liquid within the food product and away from the carton pouch (e.g., a breakfast burrito, calzone, or egg roll), or because the liquid is sufficiently bound by other ingredients within the food product.

In some embodiments, the item placed in the interior space 14 may include medicinal or nutritional products, such as pharmaceutical products, vitamins, ointment packets, nutraceuticals, nutritional supplements, protein products, workout products, bandages, first aid products, or other products. The item may be large, small, solid, packet, pourable, block, particulate, pelletized, granulated, powder, individual items, smaller containers, or in another form.

In an embodiment where the food product or non-food product may contain some moisture, the carton pouch material will handle up to 100% moisture content frozen product.

The carton pouch 10 may include non-food products in the interior space 14, including lawn care products, pet care products, toys, cosmetic products, automotive products, marine products, household cleaning products, laundry detergent powders or packets, dishwashing powders or packets, construction hardware or fasteners, or others. The non-food product may be large, small, solid, pourable, block, particulate, pelletized, granulated, powder, individual items, smaller containers, or in another form. The non-food product may be for industrial, consumer, or commercial use.

The size, shape, and design of the carton pouch 10 is unlimited and can take many forms. The housing 12 may have as few as two sides or 10 sides or more. Each side of the housing may have an exterior surface and an interior surface. The housing 12 may have a base, and a front and back panel, each with 4, 5, 6, 7, or 8 or more sides. The housing 12 may be formed by a combination of scores, perforations, cuts, and seals. The seals or closures can be made using an interlocking mechanism such as a sealable layer, a tape, a bonding material, an adhesive, or by using additional adhesive during forming on the production line. Sealing may be initiated by heat, pressure, or ultrasonic vibration. The carton pouch 10 may have one or more convex or concave curved panels or may have one or more multi-faceted display panels to enhance package aesthetics or self-standing features at the retailer. The carton pouch 10 may be designed with one self-standing plane or up to 10 self-standing planes. The front and back panels of the carton pouch 10 may comprise one or more displaying elements on the exterior surface 16, such as text, color, mark, measure, decoration, logo, surface pattern, or printed elements. The carton pouch 10 may have one or more convex or concave curved portions on its top, bottom, or sides. The carton pouch 10 may taper to a point from linear sides, like a prism, or it may taper to a plane, like a simple tent.

It is important to note that the present carton pouch provides a unique combination of both flexibility and structural rigidity. On one hand, the flexibility of the carton pouch allows for convenient manufacturing, filling, packaging, storage, and transportation. On the other hand, the present carton pouch also has sufficient rigidity and provides three-dimensional structural stability when the package is placed on shelf. Without wishing to be bound to any particular theory, it is believed that the integrated structure, multi-facet configuration, tapered corners, closures, fin or lap seals, and/or the folded or compacted portions (as described infra) may each or in combination contribute to the three-dimensional structural stability. For example, the housing 12 can be self-standing on a horizontal supporting surface that is against one side or wall of the housing 12 in either a laid or an upright position relative to the supporting surface. Advantageously, the self-standing housing 12 can withstand a weight or a force in the X, Y, and

Z directions, remain stable on the horizontal surface, and remain substantially unchanged in shape or configuration absent content therein or regardless of the type of content therein. In some embodiments, the housing 12 can withstand the application of force in the X, Y, and Z directions perpendicular to the flat surfaces of the housing 12, even in the absence of contents within the housing. In some embodiments, the semi-rigid housing 12 can enclose a content therein but does not conform to the content in shape. In comparison, traditional plastic pouches or sacks (e.g., flour or rice sacks) do not have such structural rigidity. For example, common flexible film plastic pouches usually do not hold their own shape, may not be self-standing in an upright position on shelf, or may not withstand the addition of a force in all of the X, Y, and Z directions due to the plastic material having less rigidity. Certain flexible film plastic pouches also rely on air or a modified atmosphere trapped within the film to generate a force from inside of the packaging to provide structural stability to the package. Likewise, sacks have structure due to the content inside of the sack (e.g., flour, grain, or rice) but do not have strength in the X, Y, and Z directions of the package and do not have strength in the absence of the product within the sack.

In some embodiments, the item disposed within the housing does not take up all of the volume within the interior of the housing. In some embodiments, the item takes up about at least 10%, or at least about 20%, or at least about 30%, or at least about 40%, or at least about 50%, or at least about 60%, or at least about 70%, or at least about 80%, or at least about 90%, or at least about 99% of an interior space of the housing, based on the total volume of the interior space. In some embodiments, the item takes up less than 90%, less than 80%, less than 70%, less than 60%, less than 50%, or less than 40% of the interior space of the housing, based on the total volume of the interior space. In embodiments where the items within the housing occupy less than 100% of the volume of the interior space, the housing is still able to withstand a force in the X, Y, and Z directions perpendicular to the flat surfaces of the housing. In some embodiments, the housing is not airtight and air is allowed to move in and out of the housing. In such embodiments, air or other modified atmosphere does not provide a force from within the interior of the housing.

The carton pouch 10 is constructed from paper-based material that is thinner than conventional carton material, with the thickness of the paper-based material ranging from about 0.5 points to about 24 points in some embodiments. In other embodiments, the thickness of the paper-based material may be from about 0.5 points to about 12.0 points; from about 12.0 points to about 24 points; from about 6.0 points to about 18 points; or from about 9.0 points to about 15.0 points. In a preferred embodiment, thickness of the paper-based material may be from about 6 points to about 18 points. Selecting an appropriate paper-based material weight is application specific and dependent upon several factors including, but not limited to, the intricacy of the package design, the size, weight, and degree of protection required by the product to be contained, the need for a self-standing feature, and the desired speed of the manufacturing line. In some embodiments where the carton pouch 10 is used for a frozen food application, the thickness of the paper-based material may be from about 0.5 points to about 24 points. In some embodiments, the thickness of the paper-based material may be from about 0.5 points to about 12.0 points; from about 12.0 points to about 24 points; from about 6.0 points to about 18 points; or from about 9.0 points to about 15.0 points. In a preferred embodiment where the carton pouch 10 is used in a frozen food application, the thickness of the paper-based material may be from about 5 points to about 20 points.

In an embodiment, the carton pouch 10 may hold a weight of food product or non-food product from about 0.01 pounds to about 7.5 pounds; from about 0.03 pounds to about 3.5 pounds; from about 3.5 pounds to about 7.5 pounds; from about 2.0 pounds to about 5.5 pounds; or from about 3.0 pounds to about 4.5 pounds. In a preferred embodiment, the present carton pouch may hold from about 0.125 pounds to about 5 pounds of frozen food. In an embodiment, the carton pouch may hold from about 0.125 pounds to about 5 pounds of shelf-stable food.

In an embodiment, the carton pouch 10 may form a container of from about 0.05 cubic inches to about 2,000 cubic inches of volume; from about 3 cubic inches to about 1,000 cubic inches; from about 1,000 cubic inches to about 2,000 cubic inches, from about 500 cubic inches to about 1,500 cubic inches; or from about 750 cubic inches to about 1,250 cubic inches of volume. In a preferred embodiment, the carton pouch 10 may form a container of from about 1 cubic inch to about 500 cubic inches of volume. The specific volume of the carton pouch 10 will depend at least in part on the characteristics of the food product or non-food product within the carton pouch.

The paper-based materials used in the construction of the present carton pouch include but are not limited to Solid Bleached Sulfate (SBS), Solid Unbleached Sulfate (SUS), and recyclable, biodegradable, and compostable materials. Furthermore, the paper-based material may be treated with coatings and/or laminations (including thin film laminations) for added product protection; these may include but are not limited to water-based or solvent-based coatings and polymer laminations. Additionally, the paper-based material may be partially printed (with text, designs or display-ready graphics), fully printed, and/or include a die-cut window to enhance the package appearance on shelf. Furthermore, the die cut window may include a transparent film covering for added product protection. Labels may be applied to either the paper-based rolls or the finished carton pouch to further enhance package appearance on shelf. The carton pouch 10 may also include an added zipper or closure to enable package opening and reclosure.

In a preferred embodiment, the carton pouch 10 is formed from a single paper-based roll material. In other embodiments, two or more paper-based or film-based material rolls may be used in the construction of the carton pouch 10 to either impart aesthetic features or to enhance structural integrity. This material is semi-flexible, which allows it to come in roll form and be folded, filled and sealed. After filling and sealing the package, the sides of the carton pouch 10 hold their shape and are more robust than when the paper-based material came directly off the roll, due to folding and sealing of the package. The manner of folding and sealing imparts a structural integrity to the carton pouch 10, so that the carton pouch 10 is semi-rigid. The carton pouch 10 holds its shape, even though it is made from a semi-flexible material.

The carton pouch 10 may be sealed with a lap, fin, end seals, or a combination of seals. The location of the carton pouch seal can be adjusted. The ideal location for the lap seal is application specific and dependent upon several factors including, but not limited to, the impact on package aesthetics, the intricacy of the package design, the impact to structural integrity, the impact to self-standing feature, the size and weight of the product to be contained, and the capabilities and limitations of the FFS equipment.

The carton pouch 10 may have scores, perforations, or folding lines that allow for crisper definition, reduced wrinkling, and cleaner aesthetics at the package folds and creases. The scores or perforations may also enhance rigidity for the self-standing feature, and may be in the machine direction, cross-machine direction, or other direction relative to the machine. An embodiment of the carton pouch 10 may have both scores and perforations. In some embodiments, scores, perforations, or windows may be imparted onto or cut into the web of paper-based material before it is placed on the roll, so that the paper-based material can be unrolled and formed. In other embodiments, features such as scores, perforations, or windows may be imparted onto or cut into the web of paper-based material immediately after it is unwound from the roll, just prior to the forming process. These features may aid in the forming and folding of the carton pouch 10 or may be aesthetic. Scores and perforations may be created on-line or off-line. Windows may be left open or may be covered by a material such as a transparent film.

The carton pouch 10 may have tapered corners which can be leveraged to differentiate the package shape when displayed. The corners may also be used to increase structural integrity or enhance the package self-standing feature.

The carton pouch 10 may consist of two or more containers that are attached for sale as multi-unit package. The multi-unit package may contain a perforation to allow for separation of the individual units. The multi-unit package may also be attached by an elongated sealing area. The elongated sealing area can be designed to allow the packages to fold back on each other and allow for stacking without separating the packages. Alternatively, two separate carton pouches may be attached to each other with a light adhesive that keeps the packages together on shelf, but the consumer is able to separate the packages for storage or consumption.

The carton pouch 10 is formed inline from roll material, unlike conventional cartons which are cut into flat carton blanks at a convertor and then loaded, formed, and sealed at a second manufacturing plant. The carton pouch 10 is constructed from paper-based roll material which can be scored, perforated, cut, coated, laminated, labelled, or printed at the material convertor and prior to the FFS process at the food or consumer goods manufacturing plant.

In a preferred embodiment, a rigid or semi-rigid carton pouch 10 is formed from a roll of pre-printed and pre-scored paper-based material. Most conventional pre-made cartons are separate units (i.e., not from a continuous web) that utilize standard end load and top load procedures. Utilizing pre-printed and pre-scored paper-based roll material allows for thinner and more sustainable paper materials to be used, which is better for the environment and helps businesses save money. In an embodiment, the length of the roll stock may be from about 30 meters to about 3,000 meters; from about 30 meters to about 300 meters; from about 150 meters to about 1,500 meters; from about 200 meters to about 3,000 meters; from about 1.5 meters to about 4.5 meters; or from about 2 meters to about 4 meters. In a preferred embodiment, the roll stock may be from about 450 meters to about 2,500 meters long. The length of the roll stock will vary, at least in part on the application of the roll-stock, limitations of the FFS equipment, exact shape of carton pouch to be formed, method of forming, type of food product or non-food product, or weight of paper-based material.

In an embodiment, the diameter of the roll stock may be from about 60 millimeters to about 2000 millimeters; from about 60 millimeters to about 1,000 millimeters; from about 1,000 millimeters to about 2,000 millimeters; from about 100 millimeters to about 1,400 millimeters; from about 500 millimeters to about 1,500 millimeters; from about 750 millimeters to about 1,750 millimeters. In a preferred embodiment, the roll stock may be from about 100 millimeters to about 1,000 millimeters in diameter. The diameter of the roll stock will vary, at least in part on the application of the roll-stock, exact shape of carton pouch to be formed, method of forming, type of food product or non-food product, or weight of paper-based material.

The carton pouch 10 may sit on a shelf or other flat display unit, may be able to hang, may be stackable, and may be connected to another carton pouch 10 in a multi-pouch unit.

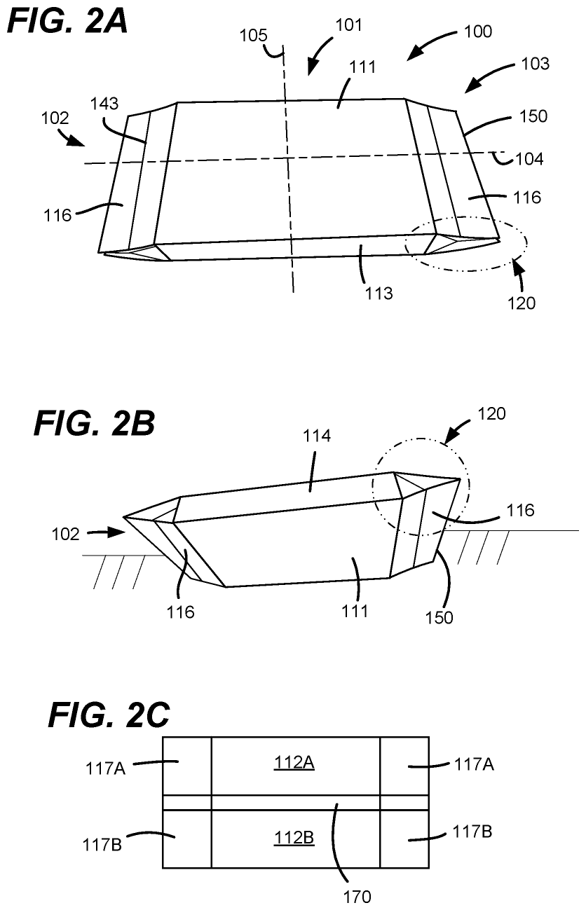

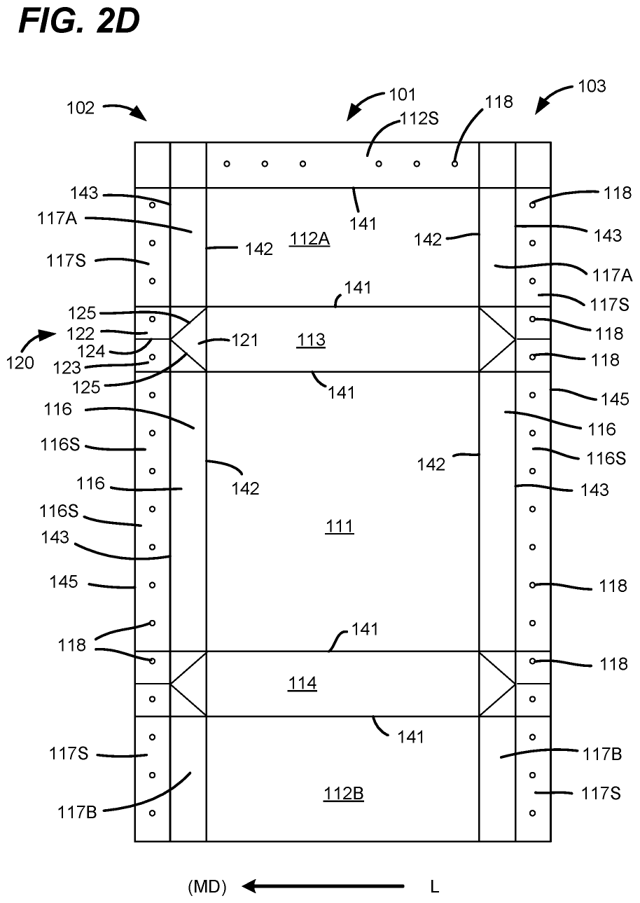

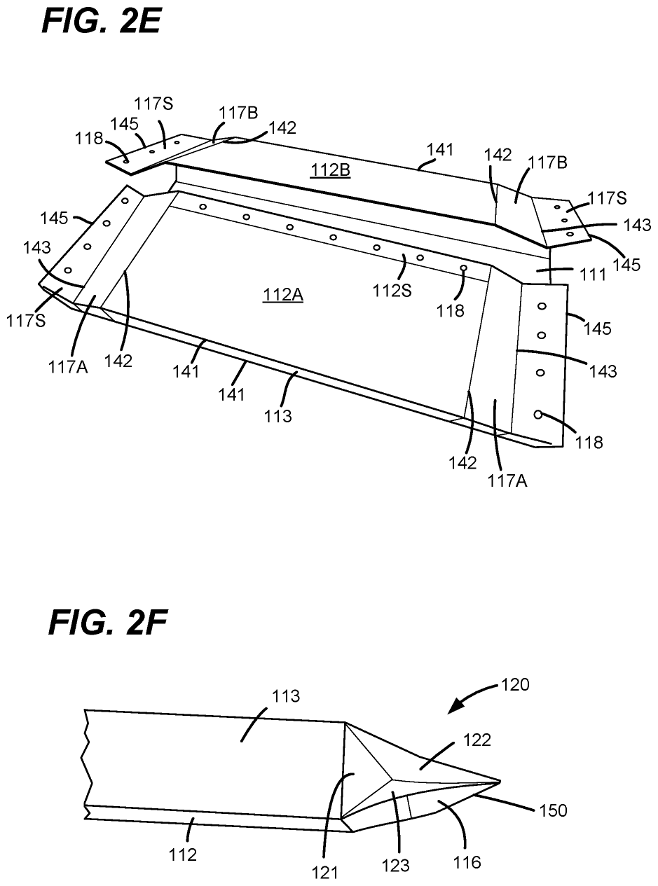

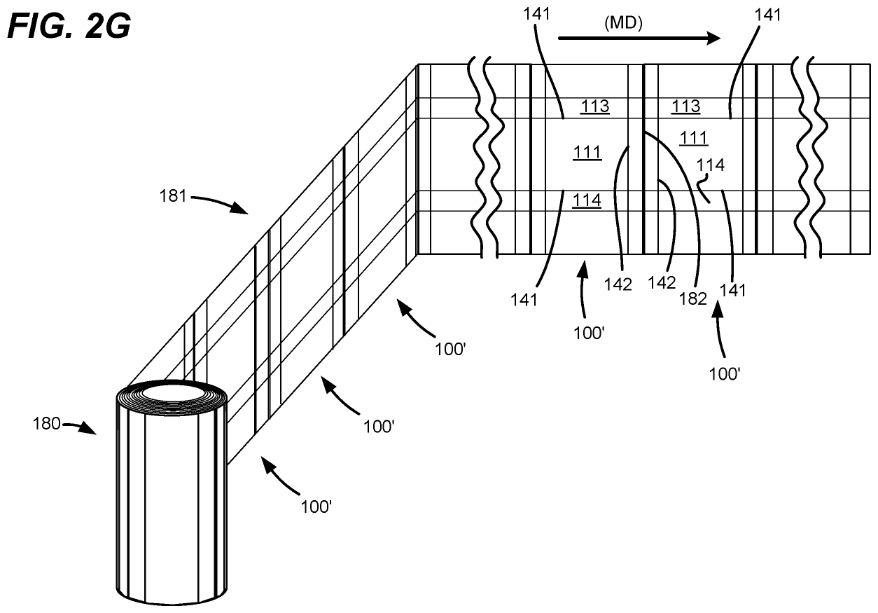

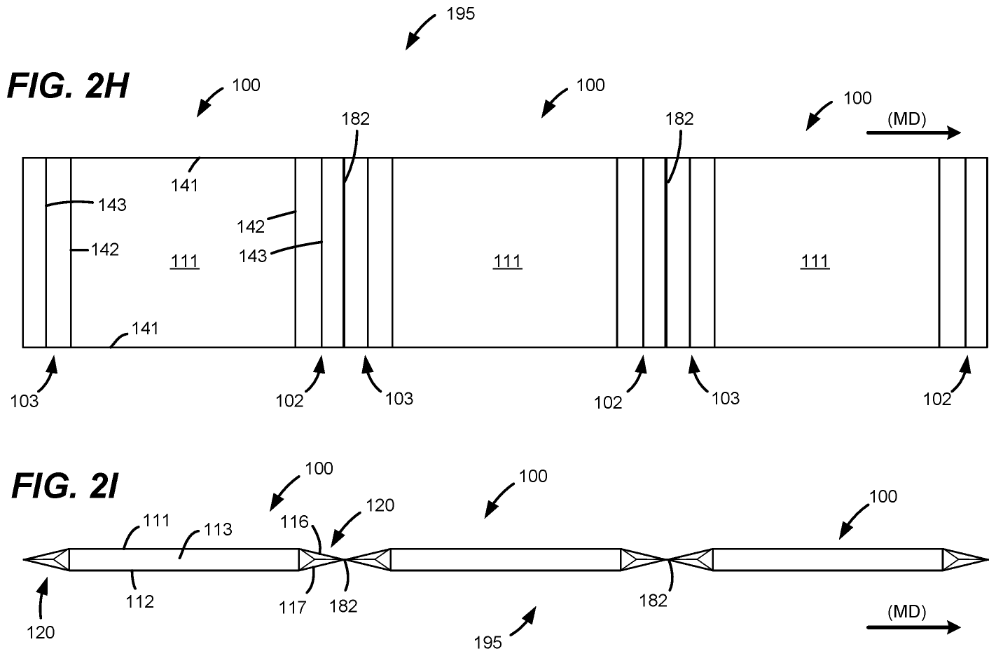

Now referring to FIGS. 2A-2I, one particular example of the carton pouch 100 and various aspects thereof will be illustrated and described. FIGS. 2A and 2B each illustrate a perspective view of an example carton pouch 100. FIG. 2C illustrates a bottom view of the carton pouch 100. FIG. 2D illustrates a top view of one example unfolded blank 100′ of the carton pouch 100. FIG. 2E illustrates a perspective view of a partially folded carton blank 100′. FIG. 2F illustrates a perspective view of one example corner portion 120 of the carton pouch 100. FIG. 2G illustrates a perspective view of one example paper roll 180 and an unwound portion thereof, where the paper roll 180 comprises a plurality of connected blanks 100′. FIG. 2H illustrates a top view of one example multi-unit package 195 comprising a plurality of connected carton pouches 100. FIG. 2I illustrates a side view of the multi-unit package 195 according to FIG. 2H.

In the illustrated example, the carton pouch 100 includes a major portion or base 101, a first side portion 102, and a second side portion 103. The first and second side portions 102 and 103 are respectively connected to the major portion 101 along a longitudinal axis 104 or in a machine direction (MD). The first and second side portions 102 and 103 may be substantially the same or different in shape and configuration.

The major portion 101 includes two opposed major walls: a first major wall 111 and a second major wall 112 generally parallel with each other. The major portion 101 also includes two opposed longitudinal side walls: a first longitudinal side wall 113 and a second longitudinal side wall 114, both generally perpendicular to the first and second major walls 111 and 112. The first longitudinal side wall 113 is connected to the major walls 111 and 112 respectively along longitudinal folding lines 141. Similarly, the second longitudinal side wall 114 is connected to the major walls 111 and 112 respectively along longitudinal folding lines 141. The carton pouch 100 may be formed from a corresponding carton blank 100′ shown in FIG. 2D. The blank 100′ is preferably a paper blank. As can be seen, the carton blank 100′ has a substantially rectangular shape. The major portion 101 is in the middle of the carton and the two side portions 102 and 103 are connected to the major portion 101 respectively along two transverse (cross MD) folding lines 142.

The second major wall 112 may further comprise two connectable portions 112A and 112B, as shown in the carton blank 100′ of FIG. 2D. The portion 112A is connected to the side wall 113, and the portion 112B is connected to the side wall 114. The portion 112A may comprise a longitudinal edge portion 112S. The edge portion 112S may further comprise an interlocking mechanism 118 disposed on either the interior surface or the exterior surface of the edge portion 112S. When folding and configuring the carton blank 100′ to form the carton pouch 100, as shown in FIG. 2E, the edge portion 112S can overlap with the portion 112B to form the second major wall 112 and further form a longitudinal closure 170 (shown in FIG. 2C) through the interlocking mechanism 118. One example of the interlocking mechanism 118 is a pre-applied adhesive element, glue, sealing material, or bonding material.

The side portions 102 and 103 of the carton pouch 100 each have two opposed and jointed side panels 116 and 117, two opposed corner portions 120, and a transverse closure or end seal 150. With respect to each side portion 102 or 103, the side panels 116 and 117 are connected to the first and the second major walls 111 and 112, respectively along transverse folding lines 142. The two side panels 116 may each slope inwardly relative to the first major wall 111. Likewise, the two side panels 117 may each slope inwardly relative to the second major wall 112.

Each of the side panel 117 may further comprise two separate and connectable portions 117A and 117B, respectively connected to the portion 112A and portion 112B along the transverse folding lines 142, as shown in the carton blank 100′ of FIG. 2D. Each of the side panels 116 and 117 may respectively have a transverse outer edge 145, and optionally a transverse score 143 between the folding line 142 and the outer edge 145. Each of the side panels 116 and 117 may respectively have an edge portion 116S or 117S between the corresponding score 143 and the outer edge 145. The edge portions 116S and 117S may each include an interlocking mechanism 118 on either the interior surface or the exterior surface or both thereof. When folding the carton blank 100′ to form the carton pouch 100, the edge portions 116S of the side panel 116 may be respectively jointed with the corresponding edge portion 117S of the side panel 117 along the outer edge 145 thereof to form the transverse closure or end seal 150 through the interlocking mechanism 118. The interlocking mechanism 118 may comprise a continuous pattern such as a strip of adhesive or tape, or an intermittent pattern such as a plurality of discrete adhesive dots.

Each of the four corner portions 120 of the carton pouch 100 has a substantially triangular outer appearance and a tapered configuration. In the corresponding carton blank 100′, each corner portion 120 includes a central panel 121 and two wing panels 122 and 123, separated by folding lines 124 and 125. As shown in FIG. 2F, the corner portion 120 may include a tucking mechanism, by which the central panel 121, and wing panels 122 and 123 are tucked inwardly to form the tapered configuration and to facilitate the formation of the transverse closure 150. The tucking mechanism of the corner portion 120 conveniently allows configuration of a single rectangular blank 100′ without the cut-off, generation of voids, or removal of a portion from the blank.

As shown in FIG. 2E, the carton pouch 100 may be formed by folding the portions 112A/112B, side walls 113 and 114, and the portions 117A/117B along the longitudinal folding lines 141 either upwardly or downwardly relatively to the major wall 111 to form a partially-closed configuration, where the portions 112A and 112B are positioned to oppose to the first major wall 111, and the portions 117A and 117B are positioned to oppose to the side panel 116. The second major wall 112 can be formed by connecting the portions 112A and 112B, whereby the side panel 117 is also formed by connecting the portions 117A and 117B. The transverse closure or end seal 150 can be formed by interlocking the connected edge portions 116S and 117S, as discussed above. The longitudinal closure 170 (shown in FIG. 2D) can be formed by interlocking the portions 112A and 112B through the interlocking mechanism 118, as discussed above. In some embodiments, the longitudinal closure 170 is a lap seal or a fin seal. When packing an item using the carton blank 100′, the item may be placed under the blank or directly on top of the blank. The walls and panels of the blank 100′ may be folded toward the item and eventually enclose the item in the interior space of the carton pouch 100.

FIG. 2G shows an example of roll stock 180 comprising a continuous web 181 that has a plurality of continuously connected blanks 100′ along the MD. Every two adjacent blanks 100′ are connected through a connection 182 between two corresponding transverse outer edges 145. The connection 182 may transversely extend between the two longitudinal folding lines 141.

The roll stock 180 may be used to feed blanks for packaging products on an FFS manufacturing line employing a continuous web-handling process. The blanks 100′ of the roll stock 180 will be each folded and configured through either a manual, or robot-assisted, or automated process to package the product and form a multi-unit package 195 comprising a plurality of carton pouches 100 that are continuously connected (as shown in in FIGS. 2H-21) without breaking the connections 182. A subsequent converting step may be performed by breaking the connections 182 between every two adjacent carton pouches to form individual and separated carton pouches 100.

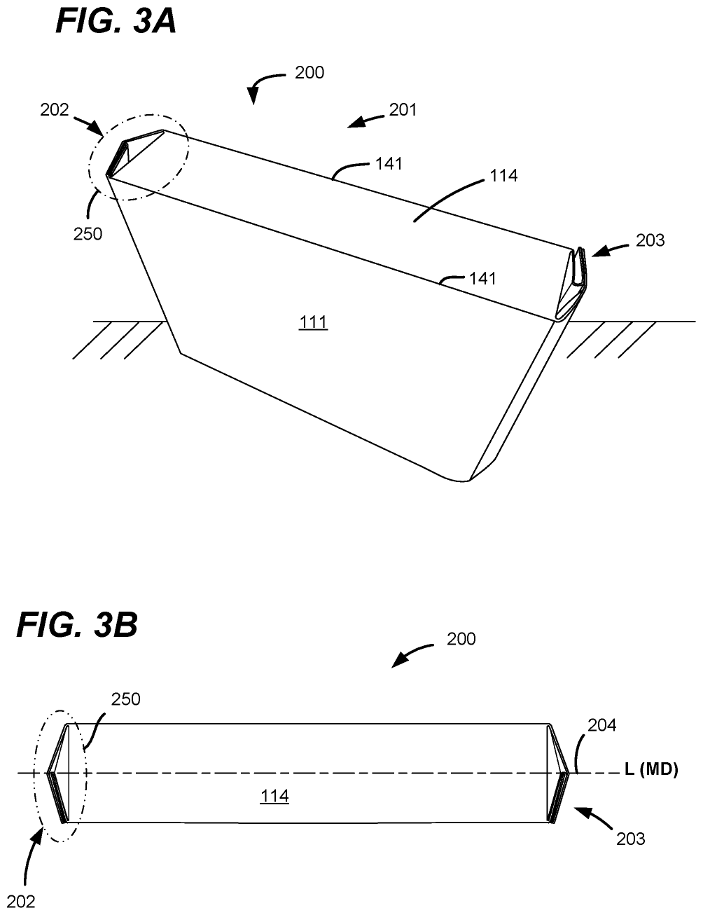

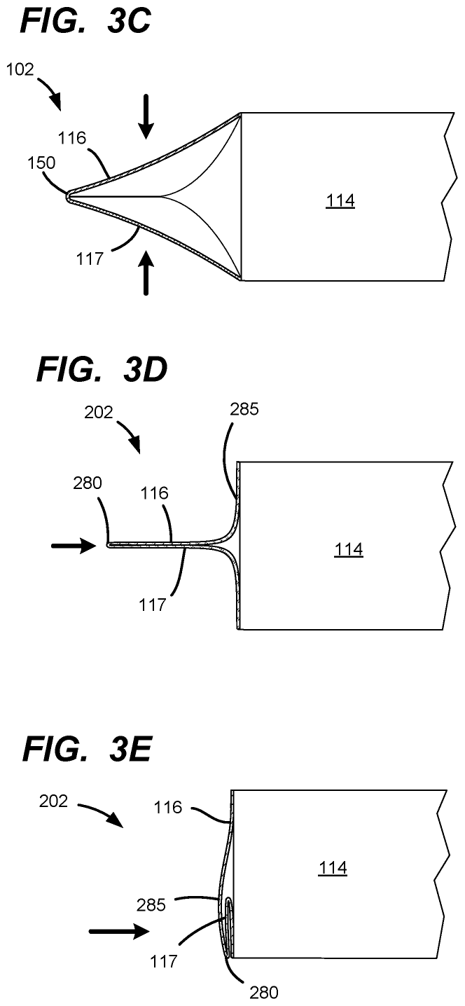

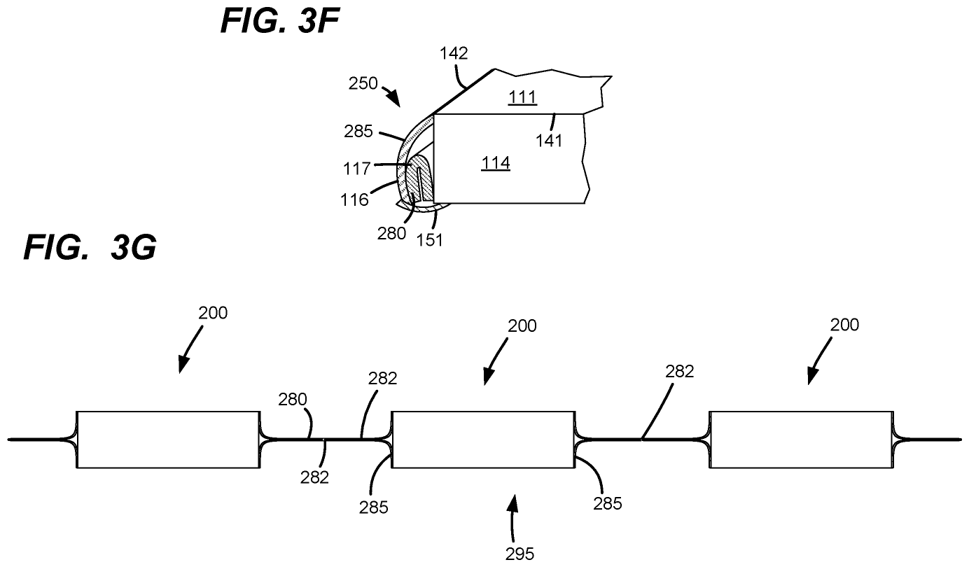

Now referring to FIGS. 3A-3G, another particular example of the carton pouch 10 according to FIG. 1 and various aspects thereof will be illustrated and described. FIGS. 3A-3B each illustrate a perspective view of one example carton pouch 200. FIGS. 3C-3E collectively illustrate a series of side views showing formation of the side portion 202/203 of the carton pouch 200. FIG. 3F illustrates a perspective view of a corner portion 250 of the carton pouch 200. FIG. 3G illustrates a side view of a multi-unit package 295 comprising a plurality of connected carton pouches 200.

Generally, the carton pouch 200 is a variation of the carton pouch 100 and has a substantially “box-like” shape with a “cleaner” outer appearance. In the illustrated example, the carton pouch 200 includes a major portion or base 201 and two side portions 202 and 203 that are respectively connected to the major portion 201 along a longitudinal axis 204 in a machine direction (MD). The major portion 201 is substantially the same as the major portion 101 of the carton pouch 100. Differently, however, the two side portions 202 and 203 of the carton pouch 200 are each substantially compacted and have a substantially flat outer appearance on the transverse side, as compared with the carton pouch 100.

The carton pouch 200 can be made by configuring the same carton blank 100′ of FIG. 2D. As an example, the carton pouch 200 may be made by further configuring the carton pouch 100. As shown in FIG. 3C, the side panels 116 and 117 of the major portion 101 of the carton pouch 100 may be compressed against each other to form a transverse side wall 285 and a transverse closure 280 protruded longitudinally from the transverse side wall 285. The transverse side wall 285 comprises the side panel 116 and is substantially flat and generally perpendicular to the major walls 111 and 112, The protruded transverse closure 280 may be further positioned flat to conform to the transverse side wall 285. As such, the side panel 117 is folded in about half and is covered by the side panel 116, as shown in FIG. 3D. As a result of compression, the corner portions 250 are each further tapered to conform to the compacted side portions 202 and 203. An interlocking mechanism may be applied to fix the flat transverse closure 280 to secure the compacted side portions 202 and 203. For example, a tape or adhesive 151 may be applied to couple the transverse closure 280 to the major wall 112 or the longitudinal side wall 113 or 114.

FIG. 3G shows a multi-unit package 295 comprising a plurality of finished carton pouches 200 that are connected through a plurality of connections 282. Similar to the carton pouch 100, the connected carton pouches 200 can be made on an FFS line using the roll stock 180 (shown in FIG. 2G). Individual carton pouch 200 may be obtained by subsequent conversion steps to break the connections 282, position the protruded transverse closure 280, and secure the flat transverse side walls 285, as discussed above.

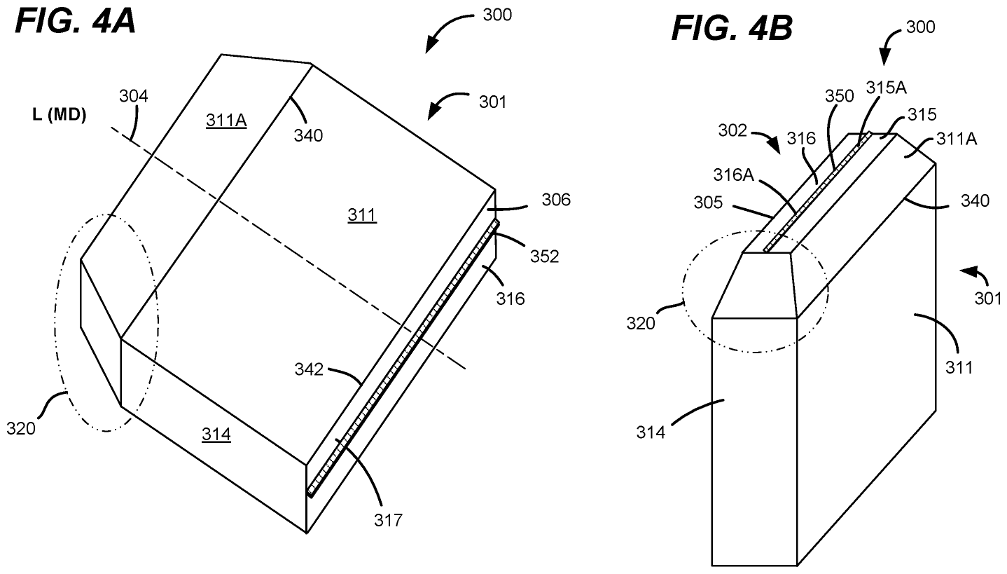

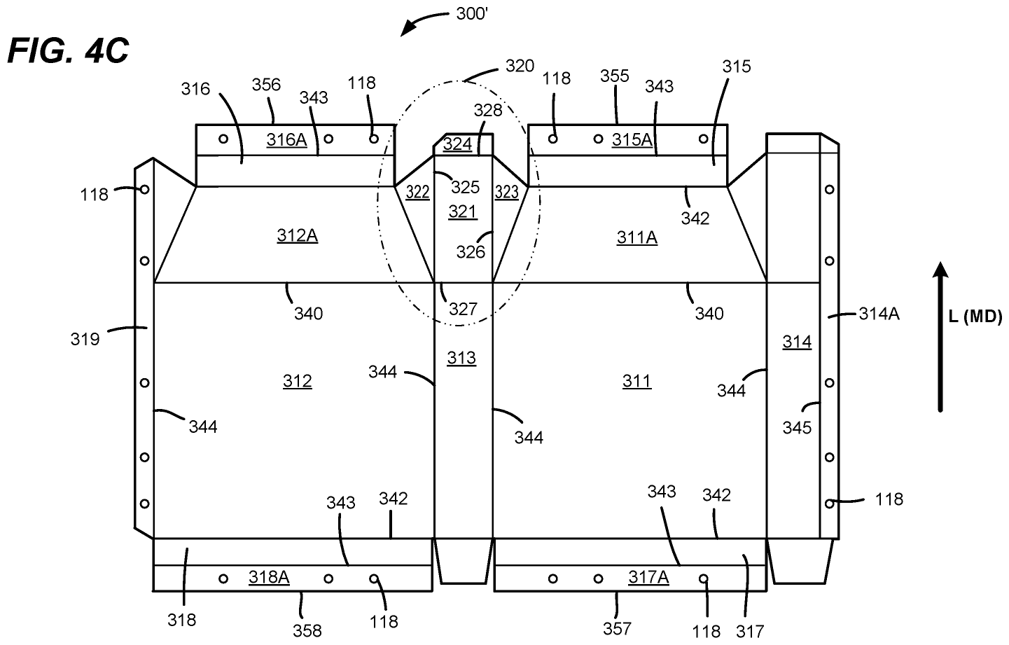

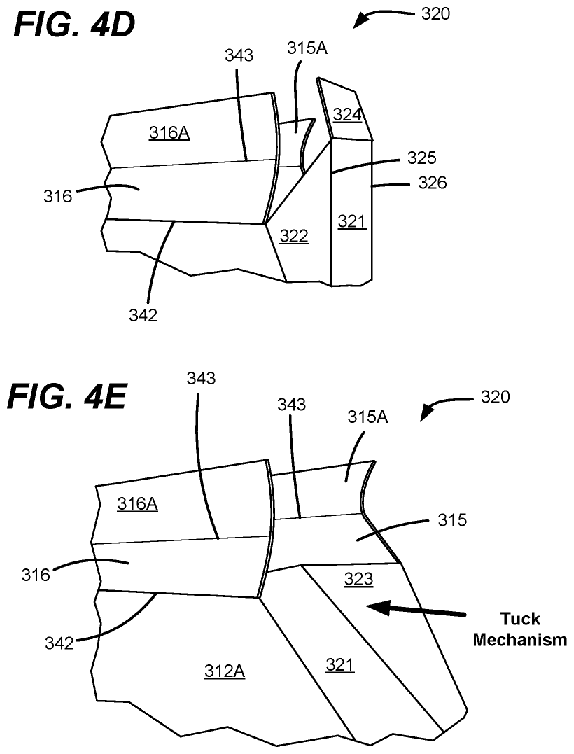

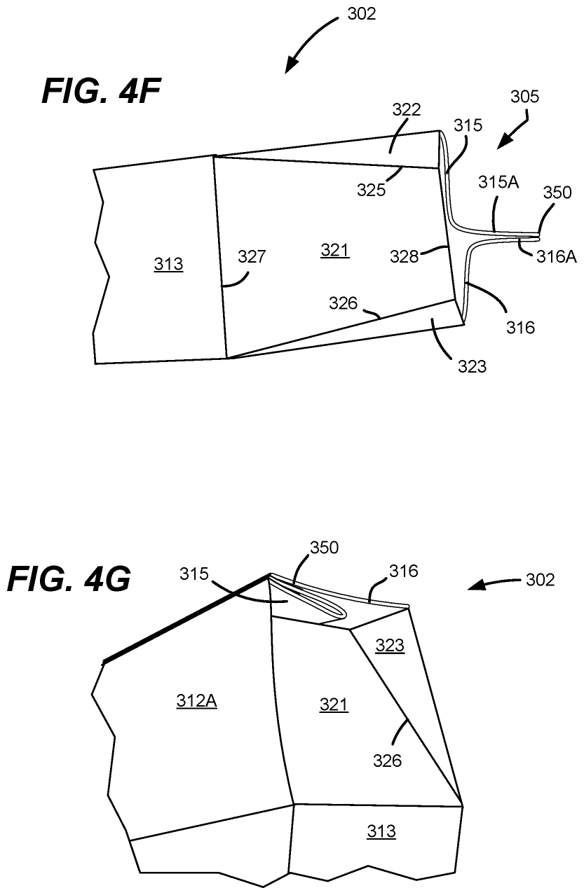

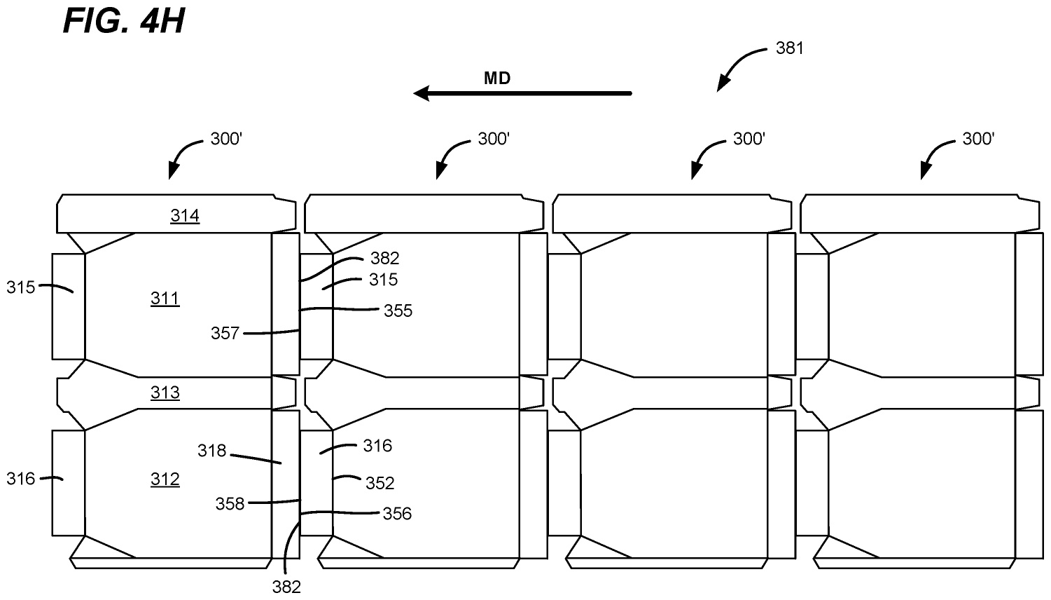

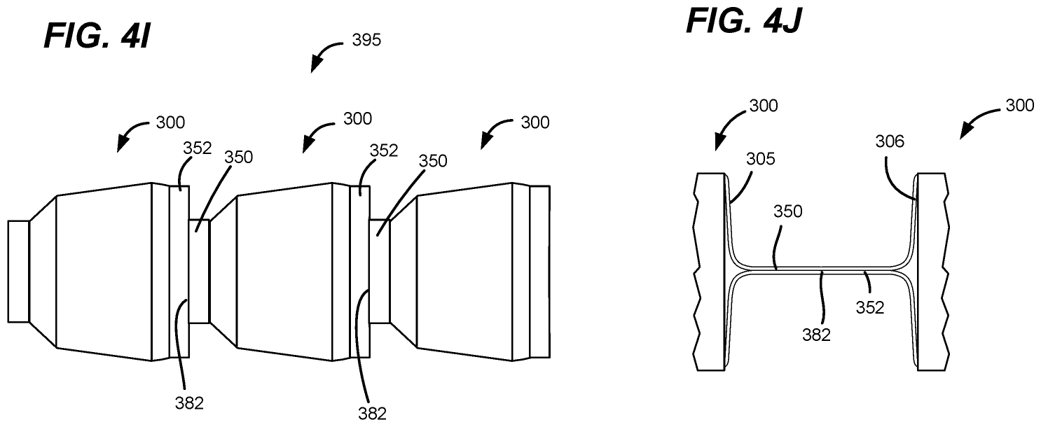

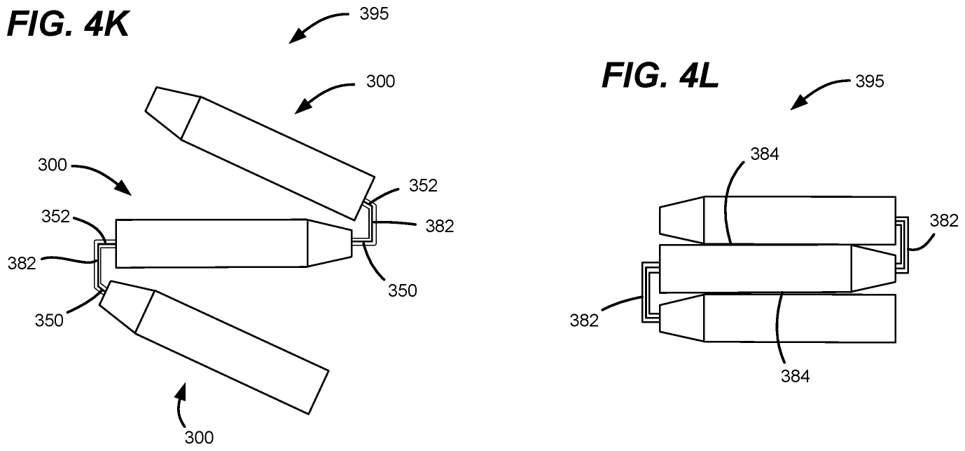

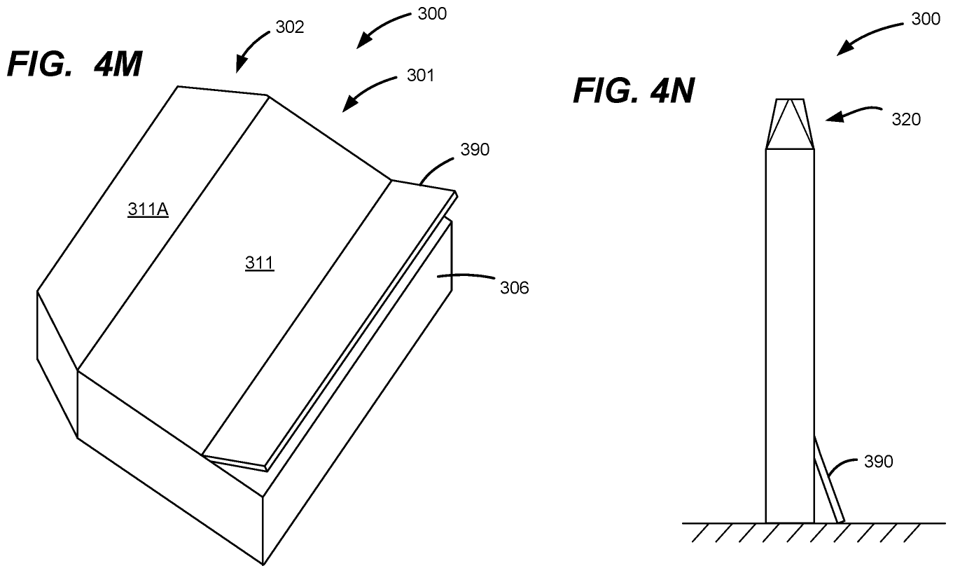

Now referring to FIGS. 4A-4N, another particular example of the carton pouch 10 according to FIG. 1 and various aspects thereof will be illustrated and described. FIGS. 4A-4B each illustrate a perspective view of one example carton pouch 300. FIG. 4C is a top view of a carton blank 300′ corresponding to the carton pouch 300. FIG. 4D illustrates a perspective view of one configuration of the corner portion 320 according to FIG. 4A. FIG. 4E illustrates a perspective view of another configuration of the corner portion 320. FIG. 4F illustrates a side view of one configuration of the side portion 302. FIG. 4G illustrates a perspective view of another configuration of the side portion 302 of FIG. 4F. FIG. 4H illustrates a top view of a continuous web 381 comprising a plurality of connected blanks 300′. FIG. 4I illustrates a multi-unit package 395 comprising a plurality of connected carton pouches 300. FIG. 4J illustrates a side view of the connection 382 between two adjacent carton pouch 300. FIG. 4K illustrates a side view of one configuration of the multi-unit package 395. FIG. 4L illustrates a side view of a stacked configuration of the multi-unit package 395. FIG. 4M illustrates a perspective view of another example of the carton pouch 300. FIG. 4N illustrates a side view of carton pouch 300 of FIG. 4M.

In the illustrated example, the carton pouch 300 includes a major portion or base 301 and a side portion 302 that is connected to the major portion 301 along a longitudinal axis 304 in the MD. The major portion 301 includes two opposed major walls: a first major wall 311, a second major wall 312, two opposed longitudinal side walls 313 and 314 that are generally perpendicular to the major walls 311/312, and a bottom wall 306 that is generally perpendicular to the major walls 311/312 and to the longitudinal side walls 313/314. The bottom wall 306 is sealed by a bottom transverse closure 352. The side portion 302 includes two opposed side panels 311A and 312A, a top wall 305, and two opposed corner portions 320. The side panels 311A and 312A are each connected to the major walls 311 and 312 respectively along a transverse folding line 340. The side panels 311A and 312A may slope inwardly relative to the major walls 311 and 312. The top wall 305 is formed by folding two top panels 315 and 316 along transverse line 342 and joining top flaps 315A and 316A along closure 350.

As shown in the blank 300′ of FIG. 4C, the top panel 315 is connected to the side panel 311A along a transverse folding line 342. The top panel 315 further includes a transverse outer edge 355, and the top flap 315A is between the edge 355 and the folding line 343. Likewise, the top panel 316 is connected to the side panel 312A and includes a transverse outer edge 356, and the top flap 316A is between the edge 356 and the folding line 343. The blank 300′ further includes two longitudinal side flaps 314A and 319 that are substantially the same in size and dimension. The side flap 314A is longitudinally connected to the side wall 314 along. The flap 319 is longitudinally connected to the second major wall 312. The two side flaps 314A and 319 may each include an interlocking mechanism 118. When folding the blank 300′ to form the carton pouch 300 in a manner similar to the carton pouch 100 or 200, the side wall 314 may be coupled to the second major wall 312 by overlapping and interlocking the two side flaps 314A and 319 through use of the interlocking mechanism 118.

As collectively shown in FIGS. 4C and 4D, the corner portion 320 includes a central panel 321, two wing panels 322 and 323, and a flap panel 324, defined by the folding lines 325, 326, 327, and 328. When folding the carton blank 300′, the panels 321, 322, and 323 may be tucked inwardly, as shown in FIG. 4E to form a tapered configuration. The flap panel 324 may be further positioned flat under the top wall 305. The flap panel 324 may be bonded to the interior surface of top wall 305 to seal the corner portion 320.

As shown in FIG. 4F, the transverse closure 350 may be formed by coupling the top flaps 315A and 316A through the interlocking mechanism 118 (FIG. 4C). The closure 350 may protrude from the top wall 305 in an upright position. Alternatively, the closure 350 may be folded in either direction to substantially conform to the top wall 305 that is generally perpendicular to the major walls 311 and 312, as shown in FIG. 4G. As such, the top wall 305 is free from a protrusion. An interlocking means such as a tape or adhesive may be used to couple the closure 350 to the side panels 311A or 312A thereby securing the flat position of the transverse closure 350. In a similar manner, the bottom closure 352 of the bottom wall 306 may also be formed and configured to be in either a protruding position or a flat position, alternatively.

In a similar manner to the carton pouches 100 and 200, a continuous roll stock or web may be used to feed blanks 300′ for packaging products on a FFS manufacturing line. FIG. 4H shows an example of a continuous web 381 (e.g., as a part of a roll stock) that has a plurality of continuously connected blanks 300′ along the MD. Every two adjacent blanks 300′ are connected through two connections 382 respectively between two corresponding edges 355 and 357 and between two corresponding edges 356 and 358. FIG. 4I shows a multi-unit package 395 comprising a plurality of connected carton pouches 300 derived from the continuous web 381 of FIG. 4H. With respect to every two adjacent carton pouches 300 as shown in FIG. 4J, the top wall 305 of one carton pouch is connected to the bottom wall 306 of another carton pouch through the connection 382 between the two protruded closures 350 and 352. A subsequent converting step may be performed by breaking the connections 382 to generate individual and separated carton pouches 300. The conversion may generate protruded closures 350 and 352, which may be respectively positioned flat to conform to the top wall 305 and bottom wall 306, as described above.

Alternatively, the connections 382 of the multi-unit package 395 may have an elongated configuration along the MD, as shown in FIG. 4K and 4L. The elongated connections 382 may allow the carton pouches 300 to stack on each other. A light adhesive 384 may be added between the stacked carton pouches 300 to hold them together on shelf and in consumer transport.

The carton pouch 300 may optionally include a seal 390 as shown in FIGS. 4M and 4N. The seal 390 may be a fin type or a lap type that is attached to the major wall 311 or 312 or both. The seal 390 in use may provide an additional means to support the carton pouch 300 in an upright self-standing position on a horizontal surface. In some embodiments, the carton pouch 300 may have slight concave or convex curves which could change the position of the lap seal. The seal 390 could be located near the middle of a carton panel or may be offset to one of the walls.

In some aspects, the present disclosure relates to a process for making a carton pouch. The carton pouch of the present disclosure can be manufactured by a vertical FFS process or a horizontal FFS process.

In a traditional horizontal FFS process for making pouches, flexible material of a web is advanced from a roll stock, a product is placed in the roll stock, a package is formed from the roll stock around the product, a belt or other method moves the package forward, the roll stock is sealed around the product, and the package is cut from the web. The carton pouch of the present disclosure uses a similar process; however, in the present disclosure, the roll stock is composed of paper-based material which may be pre-scored, cut, perforated, or a combination of those preparations. In an embodiment, the forming machine has a more gradual folding due to the stiffness of the paper-based material. The seal may be a fin or a lap seal, or other appropriate seal type. The cut off assembly can be rotary or a “traveling clamp” type, or other appropriate type. The wrapped product may also go through another process which may tuck and seal the end seals flat against the carton pouch yielding a flat end of package. A five-sided to eight-sided carton pouch may require additional cuts and scores made to the roll of paper/paperboard, and tucking actuators are needed before, after, or before and after the end seal area. This process can be used for larger food items (for example, pizza, large eggrolls), non-food items (for example, cosmetic products, pet care products), or other products.

In some embodiments, some or all of any scores, cuts, or perforations are formed or added on the manufacturing line. In some embodiments, some of the scores, cuts, or perforations are part of the roll stock and others are formed or added on the manufacturing line.

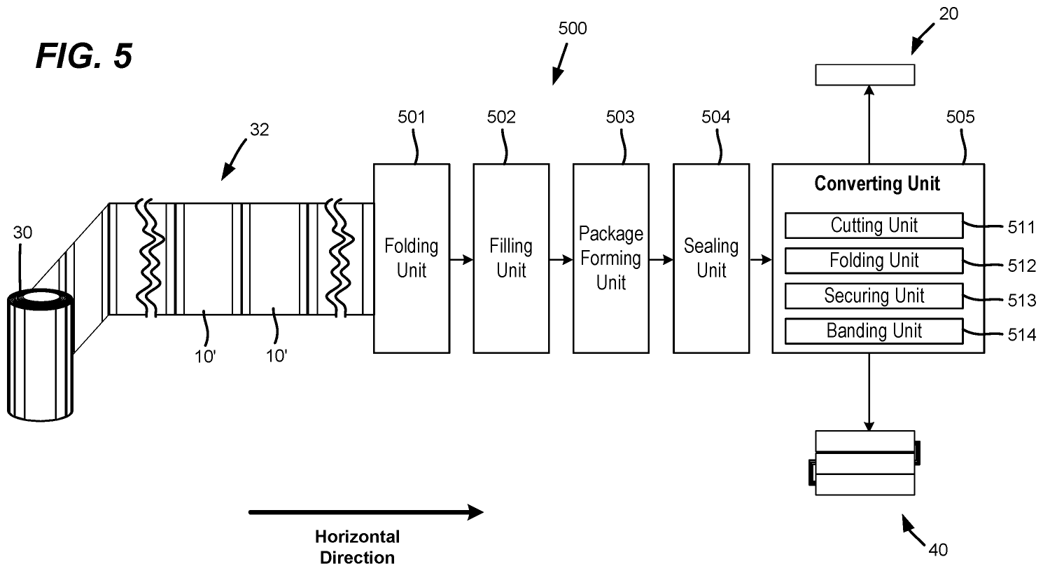

FIG. 5 illustrates a flow diagram of one example of a horizontal FFS (HFFS) process 500 according to the present disclosure. The HFFS process is operative to produce an individual packaged product 20, or a multi-unit package 40 comprising a plurality of connected packaged products 20. The HFFS process 500 includes an optional pre-folding unit 501, a filling unit 502, a package forming unit 503, a sealing unit 504, and a converting unit 505. The pre-folding unit is operative to receive a continuous web 32 of a roll stock 30. The continuous web 32 comprises a plurality of pre-formed blanks 10′ that are connected, according to the present disclosure. The pre-folding unit is operative to fold and configure each blank 10′ to form a partially-closed package. The filling unit 502 is operative to place an item such as a food product inside the partially-closed package. The package forming unit 503 is operative to continue forming the package to enclose the item in the formed package. Package forming unit 503 may include additional corner tucking. The sealing unit 504 is operative to seal closures of the package to form a sealed package.

The converting unit 505 may include one or more sub-units, including a cutting unit 511, a folding unit 512, a securing unit 513, or a banding unit 514. The cutting unit 511 is operative to break connections between sealed packages or to cut off extra material from the package. The folding unit 512 is operative to further configure the sealed package. For example, a protruded closure on a side wall of the carton pouch (as shown in FIGS. 3D and 4F) may be positioned at 512 to form a substantially flat transverse side wall with a cleaner appearance. The securing unit 513 is operative to apply a tape or bonding materials to finish-forming the sealed package. For example, a tape may be applied at 513 to couple or fix a transverse closure that conforms to a flat transverse wall (as shown in FIG. 3E). The securing unit 513 may be operative to convert the multi-unit package 40, e.g., through application of an adhesive between stacked carton pouches to hold the stacked configuration (as shown in FIG. 4L). The banding unit 514 is operative to band or bundle a plurality of carton pouches.

In a traditional vertical form fill seal (FFS) process, flexible material is advanced from a roll stock around a forming machine and filling tube, a product is placed in the roll stock via a filling tube, a package is formed from the roll stock around the product, sealed around the product, and the package is cut from the web of the roll stock. The carton pouch of the present disclosure uses a similar process; however, in the present disclosure, the roll stock is composed of paper-based material which may be pre-scored, cut, perforated, or a combination of those preparations in some embodiments. In other embodiments, the paper-based material may not be pre-scored or cut. The seal may be a fin or a lap seal, or other appropriate seal type. The cut off assembly can be rotary or a “traveling clamp” type, or other appropriate type. The wrapped product may also go through another process which may tuck and seal the end flat against the carton pouch yielding a flat end of package. A five-sided to eight-sided carton pouch may require additional cuts and scores made to the roll of paper or paperboard, and tucking actuators may be needed before, after, or before and after the end seal area. This process can be used for flowable food items (for example, stir-fry, fruits, vegetables, noodles), small food items (for example, nuts, dried fruit, cereal, granola, mints), non-food items (for example, cosmetic products, pet care products), or other products.

In some embodiments, some or all of the scores, cuts, or perforations are formed or added on the manufacturing line. In some embodiments, some of the scores, cuts, or perforations are part of the roll stock and others are formed or added on the manufacturing line.

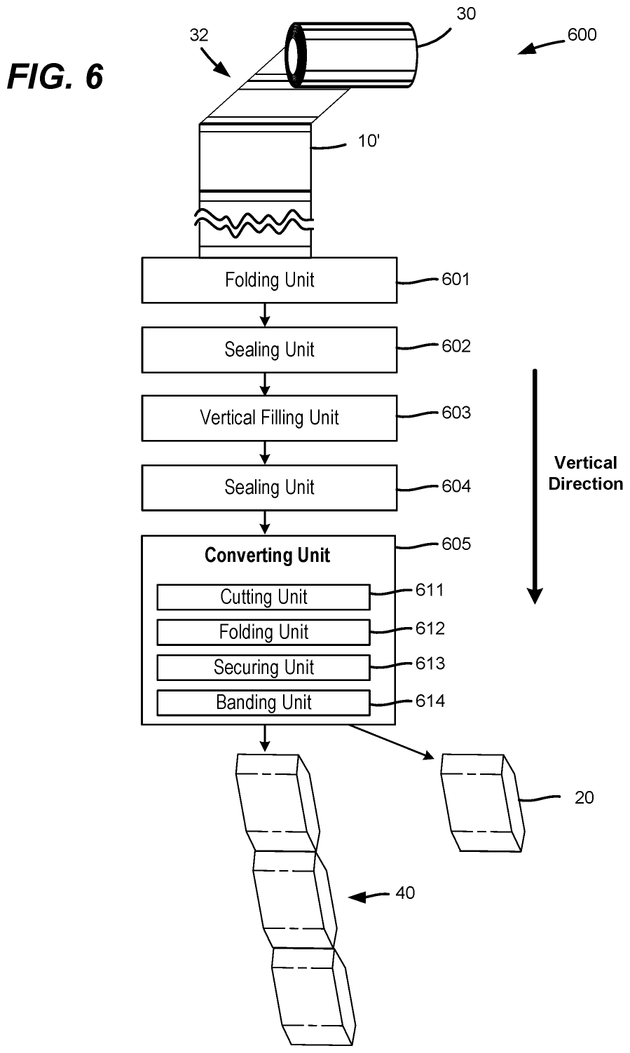

FIG. 6 illustrates a flow diagram of one example of a vertical FFS (VFFS) process 600 according to the present disclosure. Similarly, the VFFS process is operative to produce an individual packaged product 20, or a multi-unit package 40 comprising a plurality of connected packaged products 20. The VFFS process 600 includes a forming unit 601, a sealing unit 602, a vertical filling unit 603, a package forming unit 604, and optionally a converting unit 605. The forming unit 601 is operative to receive a continuous web 32 of a roll stock 30. The continuous web 32 comprises a plurality of pre-formed blanks 10′ that are connected, according to the present disclosure. The forming unit 601 is operative to configure each blank 10′ to form a partially-closed package. The sealing unit 602 is operative to seal the side wall and bottom end of the partially closed package and to form a top opening thereof. The vertical filling unit 603 is operative to introduce a flowable or semi-flowable item into the partially-closed package from the top opening. The package forming unit 604 is operative to close the top opening and seal the top end after filling to form a sealed package.

Similar to the converting unit 505 of the HFFS, the converting unit 605 of VFFS is operative to convert the sealed package into either individual packaged product 20 or the multi-unit package 40. Similarly, the converting unit 605 may further include one or more subunits including a cutting unit 611, a folding unit 612, a securing unit 613, and/or a banding unit 614. Various subunits of the converting unit 605 will not be repeated.

In a preferred embodiment, pre-printed and pre-scored roll material is fed into the HFFS 500 or VFFS 600 for forming. In the preferred embodiment, the HFFS 500 or VFFS 600 is similar to a traditional HFFS or VFFS equipment; however, since the material is paper-based rather than plastic-based, the transitions for the folding, guiding, and sealing of the material must be more gradual and may take more length in the machine direction of travel. Unlike plastic based material, paper-based material will retain its sharp creases or folds once folded.

The roll of paper-based material is fed into the HFFS 500 or VFFS 600 with gradual forming transitions. In several embodiments, the package may be formed around a mandrel or collar. In one embodiment, the base material is formed into a squared tube using a lap seal or fin seal. The base material may contain a sealant layer or a sealant area which can be sealed by heat and pressure. The materials can also be sealed with cold seal adhesive (cold sealant), hot melt adhesive, or ultrasonic sealing. The two end seals of the carton pouch may be applied to the package immediately before filling, immediately after filling, or one end may be sealed before filling and the other end may be sealed after filling. In one embodiment, the package is simultaneously cut from the roll stock and sealed. In another embodiment, the package is cut from the web and then sealed. In a preferred embodiment, the package is sealed or closed and then cut from the web. Alternately, a zipper or other closure feature may be applied prior to lap or fin sealing the end to enable a consumer reclose feature.

An embodiment includes a web of a paper-based material for the package walls. Each of the wall members comprises: a base portion; a contiguous base wall surrounding the base portion integrally formed with the base portion; and a top portion integrally formed with the base wall portion. The carton pouch is oriented in a generally horizontal or vertical position, and the wall members are joined at the bottom by a lap or fin seal. In the preferred embodiment, the paper-based material is advanced continuously. In other embodiments, the paper-based material may be advanced intermittently.

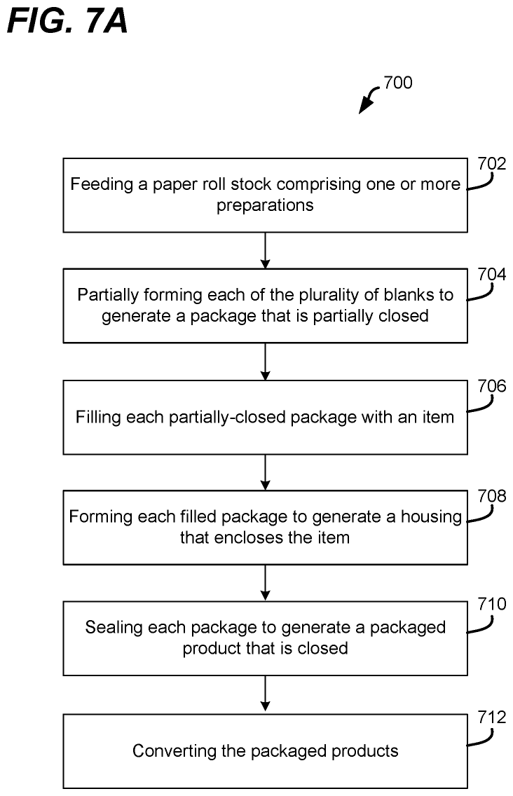

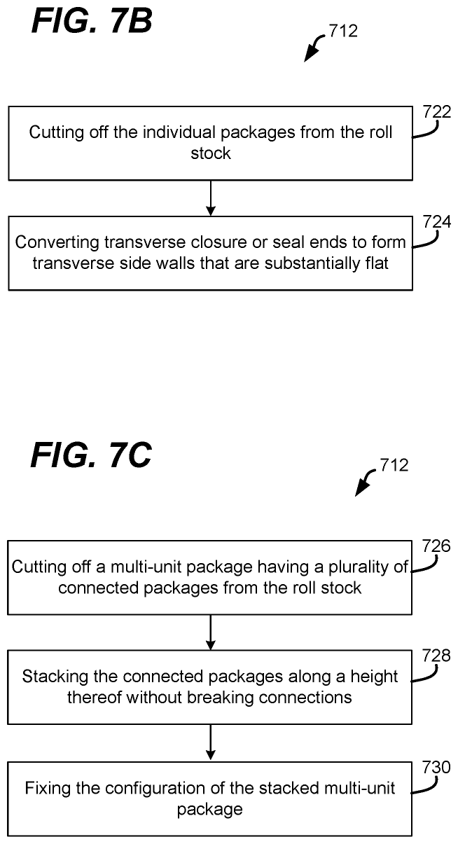

In some aspects, the present disclosure relates to a method for making a carton pouch according to the present disclosure. FIG. 7A illustrates a block diagram of one example method 700. In the illustrated example, the method 700 includes at least one of the following operations 702, 704, 706, 708, 710, 712, or combinations thereof. The method 700 may be implemented through the use of the HFFS 500 or the VFFS 600 of the present disclosure.

Operation 702 includes feeding a paper roll stock comprising one or more preparations. The preparations may be a plurality of connected carton blanks according to the present disclosure. Operation 704 includes partially forming each of the plurality of blanks to generate a package. At 704, one or more closures or end seals may be formed to at least partially close the housing and generate at least one opening for an item to be placed therein. Operation 706 includes filling the partially-closed package with an item through the at least one opening. The item may be any product such food or non-food product described herein. Operation 708 includes forming each filled package to generate a housing that encloses the item. Operation 710 includes closing the at least one opening and sealing each package to form a packaged product that is closed. Various types of seal or closure, such as fin seal or lap seal, may be formed during the operations of the method 700.

Operation 712 includes converting the packaged products into individual packaged products or multi-unit packaged products. FIG. 7B illustrates one exemplary embodiment of operation 712. In the illustrated embodiment, the operation 712 includes operation 722 and optional operation 724. At 722, individual sealed packages are cut off from the roll stock, e.g., by breaking a connection between every two adjacent packages. The disconnected packages may have transverse closures or end seals that protrude from the side walls. At 724, the protruded closures or end seals are transformed, e.g., by folding or taping, to produce transverse side walls with a substantially flat appearance, as described above.

FIG. 7C illustrates another exemplary embodiment of operation 712. In the illustrated embodiment, the operation 712 includes operation 726 and optional operations 728 and 730. At 726, a multi-unit package having a plurality of connected packages is cut off from the roll stock. The multi-unit package may have at least 2, at least 3, at least 4, at least 5, at least 10, at least 20, or at least 50 packages that are connected. At 728, the connected packages of the multi-unit package are stacked over each other along a height of the packages via elongated connections (e.g., connection 382 of FIG. 4L). At 730, the stacked multi-unit package may be fixed in shape by applying a light adhesive or bonding material between every two stacked packages or by banding the multi-unit package.

In one particular embodiment, the method 700 is implemented through use of the HFFS process of the present disclosure to produce a carton pouch package. In the embodiment, a product is spaced into the middle of the package by a smart belt or lug system and flows at a similar rate as the carton pouch material. The former may have more gradual folding due to the stiffness of the paper-based material as compared to standard FFS equipment. The carton pouch material is wrapped around the product and serves as the transport method (bottom friction) for the product to move forward. As the product and packaging material move together into the lap or fin seal section of the process, the material can be driven by a vacuum belt or friction belt. A sealing wheel may assist in driving the roll stock forward. After the lap and fin seal are executed (by glue, heat sealing, or ultrasonic sealing; compressed by a rotary seal, sealing jaws, sealing wheels, or other sealing technology) the package and product move together to the end sealing section of the equipment where the package is sealed, by glue, heat sealing, or ultrasonic sealing. The cut off and end seal assembly can be rotary, stationary, or a “traveling clamp,” or “traveling beam” type. The wrapped product may also go through another process which may tuck and seal the end seals flat against the carton pouch (by glue, heat sealing, or ultrasonic sealing) flattening the end(s) of the package.

In one particular embodiment, the method 700 is implemented through use of the VFFS process of the present disclosure to produce a carton pouch package. A VFFS process may be used for free-flowing food (for example, stir fry, mandu, pot stickers, wontons, cereal, dried fruits, granola, nuts) and is filled using scales and a filling tube. The carton pouch uses a similar process to the standard vertical FFS system; however, the roll of paper-based material is pre-scored and cut. The paper-based material is fed from above (in some embodiments, around a filling tube). The tube of material is sealed longitudinally by either a fin or lap seal. The fin or lap seal is executed (by glue, heat sealing, or ultrasonic sealing) (compressed by a rotary seal, sealing jaws or other sealing technology). The package and product move together to the end sealing section of the equipment where the package is sealed, by glue, heat sealing, or ultrasonic sealing. The cut off and end seal assembly can be rotary, stationary, or a “traveling clamp” or “traveling beam” type. For a five-sided to twelve-sided carton pouch additional cuts and scores are made to the roll of paper or paperboard, and tucking actuators are needed before, after, or before and after the end seal area. The wrapped product may also go through another process which may tuck and seal the end seals flat against the carton pouch (by glue, heat sealing, or ultrasonic sealing) yielding a package with flat ends.

In some embodiments of either a horizontal or vertical FFS process, the roll stock may advance at a rate of about 0.1 meters per second to about 4 meters per second; about 0.1 meters per second to about 1 meters per second; of about 0.5 meters per second to about 2 meters per second; of about 1 meters per second to about 3 meters per second; of about 2 meters per second to about 4 meters per second; or about 0.1 meters per second to about 3 meters per second. In a preferred embodiment, the roll stock may advance at a speed of about 0.2 meters per second to about 1.6 meters per second. The speed of advancement of the roll stock will vary, based at least in part on the application of the roll-stock, exact shape of the carton pouch to be formed, method of forming, type of food product or non-food product, or weight of paper-based material.

The above specification, examples and data provide a complete description of the manufacture and use of the composition of the invention. Since many embodiments of the invention can be made without departing from the spirit and scope of the invention, the invention resides in the claims hereinafter appended.

1. A package comprising a housing, wherein the housing comprises:
a base comprising two opposed major walls, and two longitudinal side walls opposed to each other;
a first side portion and a second side portion integrally formed with the base, wherein the two side portions are respectively connected to the base, wherein each side portion comprises two opposed side panels, two opposed corner portions, and a transverse closure,
wherein each side panel is connected to the adjacent major wall along a transverse line, wherein the two opposed side panels of each side portion are jointed and sealed by an interlocking mechanism to form the transverse closure, and wherein the corner portions are tapered,
wherein the housing is made of paper and is semi-rigid.

2. The package of claim 1, wherein the housing is self-standing on a horizontal surface and remains substantially unchanged in shape, wherein the horizontal surface is against one of the major walls or one of the longitudinal side walls.

3. The package of claim 2, wherein the housing withstands a weight regardless of content in the housing.

4. The package of claim 1, wherein at least one of the side portions is substantially compacted.

5. The package of claim 4, wherein at least one compacted side portion forms a transverse side wall that is substantially flat and generally perpendicular to the two major walls.

6. The package of claim 5, wherein at least one closure protrudes from the corresponding transverse side wall.

7. The package of claim 5, wherein at least one closure is positioned flat to conform to the transverse side wall.

8. The package of claim 7, wherein the flat closure is fixed by an adhesive.

9. The package of claim 1, further comprising at least one fin seal or lap seal on at least one of the major walls along the longitudinal direction.

10. The package of claim 1, wherein the interlocking mechanism comprises a sealable layer, a tape, a bonding material, an adhesive.

11. The package of claim 1, wherein the package is made from a paper blank comprising a plurality of preparations selected from cut-offs, perforations, scores, folding lines, and combinations thereof.

12. The package of claim 1, wherein the package is formed from a paper roll comprising a continuous web having a plurality of connected paper blanks.

13. The package of claim 1, further comprising a food product disposed and enclosed in the housing.

14. The package of claim 1, wherein the housing is made of a paper-based material having a thickness from about 0.5 points to about 24 points.

15. A multi-unit package, comprising a plurality of the packages according to claim 1, wherein every two adjacent packages are connected via a connection between one of the transverse closures of one package to one of the transverse closures of the other package.

16. The multi-unit package of claim 15, wherein the multi-unit package is made from a paper roll comprising a continuous web having a plurality of connected paper blanks.

17. The multi-unit package of claim 15, wherein the connection is elongated along the longitudinal direction.

18. The multi-unit package of claim 17, wherein the packages are stacked over each other and wherein the elongated connections are folded without breaking.

19. The multi-unit package of claim 18, further comprising an adhesive between every two adjacent packages to maintain the stacked configuration.

20. A method for making a package, the method comprising:
feeding a paper roll stock comprising a continuous web having a plurality of connected blanks;
partially forming each of the plurality of blanks to generate a package, wherein the package is partially closed and comprises at least one opening;
filling each partially-closed package with an item through the at least one opening;
forming each filled package to generate a housing that encloses the item; and
closing the housing to form a packaged product.

21. The method of claim 20, wherein the blank comprises a plurality of preparations selected from cut-offs, perforations, scores, folding lines, and combinations thereof.

22. The method of claim 20, wherein the closed housing comprises:
a base comprising two opposed major walls, and two longitudinal side walls opposed to each other; a first side portion and a second side respectively connected to the base, wherein each side portion comprises two opposed side panels, two opposed corner portions, and a transverse closure,
wherein each side panel is connected to the adjacent major wall along a transverse line, wherein the two opposed side panels of each side portion are jointed and sealed by an interlocking mechanism to form the transverse closure, and wherein the corner portions are tapered.

23. The method of claim 20, wherein the package is made on a horizontal form-fill-seal (FFS) line or a vertical form-fill-seal (FFS) line.

24. The method of claim 20, wherein every two adjacent packaged products are connected via a connection between a transverse closure of one packaged product and a transverse closure of another packaged product.

25. The method of claim 24, further comprising: cutting off the individual packaged products from the roll stock.

26. The method of claim 25, further comprising: converting or transforming the individual packaged product to form at least one transverse side wall that is substantially flat.

27. The method of claim 26, further comprising positioning transverse closures or end seals that protrude from the transverse side walls to conform to the transverse side wall and securing the flat closures.

28. The method of claim 20, further comprising: cutting off a multi-unit package from the roll stock, wherein the multi-unit package has a plurality of connected packaged products.

29. The method of claim 28, further comprising: stacking the connected packages over each other along a height thereof without breaking the connections.

30. The method of claim 29, further comprising: fixing the configuration of the stacked multi-unit package.
